(19) United States
(12) Patent Application Publication
(10) Pub. No.: US 2016/0055526 A1
(43) Pub. Date: Feb. 25, 2016

(54) INFORMATION PROCESSING DEVICE, INFORMATION PROCESSING METHOD, AND INFORMATION PROCESSING PROGRAM

(71) Applicant: RAKUTEN, INC., Setagaya-ku,Tokyo (JP)

(72) Inventor: Kaishi OKUNO, Tokyo (JP)

(73) Assignee: Rakuten, Inc., Tokyo (JP)

(21) Appl. No.: 14/778,708

(22) PCT Filed: Mar. 29, 2013
(86) PCT No.: PCT/JP2013/059561

§ 371 Date: Sep. 21, 2015

(51) Int. Cl. G06Q 30/02; G06F 17/30

(52) U.S. Cl. CPC G06Q 30/0255; G06F 17/30893

(57) ABSTRACT

There are provided an information processing device, an information processing method, and an information processing program capable of determining an advertisement according to the intension of a supervisor supervising a page, as an advertisement to be displayed on a page supplied from a web site. The information processing device acquires a keyword specified from a page on which an advertisement display area used for an advertisement is arranged, and acquires history information of a supervisor supervising the page. Then, the information processing device selects advertisements corresponding to the acquired keyword, and determines an advertisement to be displayed in the advertisement display area of the page among the selected advertisements, based on the acquired history information.

### TECHNICAL FIELD

The present invention relates to a technical field of a system capable of providing an advertisement associated with a content of an article registered in a web site to a user and the like.

### BACKGROUND ART

Conventionally, an advertisement distribution system capable of providing an advertisement associated with a content of an article (content) registered in a web site has been known (for example, Patent Literature 1). In such a system, a keyword or a topic is extracted from an advertisement placement target content of a web site in which an advertisement is placed, and, in a case where an access to the advertisement placement target content is requested by a reader from a terminal, a search for an advertisement is executed using the keyword or the topic that has been extracted, and a content to which an advertisement is attached is provided for the reader's terminal. In this way, the reader can acquire an advertisement relating to an accessed content.

### CITATION LIST

### Patent Literature

Patent Literature 1: JP 2007-286833 A

### SUMMARY OF THE INVENTION

### Problem to be Solved by the Invention

Meanwhile, for example, in a case where web sites in which articles are registered (posted) are assigned to each of a plurality of users, each user serves as a supervisor supervising pages provided from the web sites assigned to the user. However, according to the conventional technology as described above, advertisements according to the intention of a supervisor supervising such pages are not necessarily selected. For this reason, it is difficult to cause a reader to read advertisements according to the intention of the supervisor supervising the pages.

The present invention is devised in consideration of the above-described points and the like, and an object thereof is to provide an information processing device, an information processing method, and an information processing program capable of determining advertisements according to the intension of a supervisor supervising a page as advertisements to be displayed on a page supplied from a web site.

### Means for Solving the Problem

In order to solve the above problem, the invention of claim 1 is an information processing device comprising:

a first acquiring means that acquires a keyword specified from a page, on which an advertisement display area used for displaying an advertisement is arranged, and which is displayable on a display screen of a terminal device;

a second acquiring means that acquires history information of a supervisor supervising the page; and

a determining means that determines an advertisement to be displayed in the advertisement display area of the page, based on the keyword acquired by the first acquiring means and the history information acquired by the second acquiring means, from a storing means storing information of a plurality of advertisements.

According to this invention, an advertisement according to the intention of the supervisor supervising the page can be determined as an advertisement to be displayed on the page.

The invention of claim 2 is the information processing device according to claim 1,

wherein, in a case where the keyword acquired by the first acquiring means represents a category of a commodity, the determining means determines an advertisement corresponding to the keyword.

According to this invention, an advertisement according to the intention of the supervisor supervising the page can be determined.

The invention of claim 3 is the information processing device according to claim 1,

wherein, in a case where an evaluation made by the supervisor for the keyword is positive, the determining means determines an advertisement corresponding to the keyword.

According to this invention, an advertisement according to the intention of the supervisor supervising the page can be determined.

The invention of claim 4 is the information processing device according to any one of claims 1 to 3,

wherein the determining means determines an advertisement of which a score calculated based on the keyword satisfies a predetermined condition, as an advertisement to be displayed in the advertisement display area, with high priority among advertisements corresponding to the keyword.

According to this invention, it can be prevented that, in the display rank that is based on the score, an advertisement of which the rank or the score is too far from an advertisement having a high score rank is determined as an advertisement to be displayed in the advertisement display area with high priority.

The invention of claim 5 is the information processing device according to any one of claims 1 to 3,

wherein the determining means determines an advertisement of which a bid amount designated by an advertiser for displaying the advertisement in the advertisement display area satisfies a predetermined condition, as an advertisement to be displayed in the advertisement display area, with high priority among advertisements corresponding to the keyword.

According to this invention, it can be prevented that, in the display rank that is based on input amounts, an advertisement of which the bid amount rank is too far from an advertisement having a high bid amount rank is determined as an advertisement to be displayed in the advertisement display area with high priority.

The invention of claim 6 is the information processing device according to any one of claims 1 to 3,

wherein the determining means determines an advertisement of a commodity purchased by the supervisor, as an advertisement to be displayed in the advertisement display area, with high priority among advertisements corresponding to the keyword.

According to this invention, an advertisement according to the intention of the supervisor supervising the page can be determined as an advertisement to be displayed on the page.

The invention of claim 7 is the information processing device according to claim 6,

wherein the determining means determines an advertisement of a commodity purchased within a predetermined period before date and time of registration of an article including the keyword in the web site, as an advertisement to be displayed in the advertisement display area, with high priority.

According to this invention, an advertisement according to the latest intention of the supervisor supervising the page can be determined as an advertisement to be displayed on the page.

The invention of claim 8 is the information processing device according to claim 6,

wherein the determining means determines an advertisement of a commodity of which purchasing date and time is closest to date and time of registration among commodities purchased before the date and time of the registration of an article including the keyword in the web site, as an advertisement to be displayed in the advertisement display area, with high priority.

According to this invention, an advertisement according to the latest intention of the supervisor supervising the page can be determined as an advertisement to be displayed on the page.

The invention of claim 9 is the information processing device according to any one of claims 1 to 3,

wherein the determining means determines an advertisement of a commodity read by the supervisor, as an advertisement to be displayed in the advertisement display area, with high priority, among advertisements corresponding to the keyword.

According to this invention, an advertisement according to the intention of the supervisor supervising the page can be determined as an advertisement to be displayed on the page.

The invention of claim 10 is the information processing device according to claim 9,

wherein the determining means determines an advertisement of a commodity read within a predetermined period before date and time of registration of an article including the keyword in the web site, as an advertisement to be displayed in the advertisement display area, with high priority.

According to this invention, an advertisement according to the latest intention of the supervisor supervising the page can be determined as an advertisement to be displayed on the page.

The invention of claim 11 is the information processing device according to claim 9,

wherein the determining means determines an advertisement of a commodity of which reading date and time is closest to the date and time of the registration among commodities read before the date and time of the registration of an article including the keyword in the web site, as an advertisement to be displayed in the advertisement display area, with high priority.

According to this invention, an advertisement according to the latest intention of the supervisor supervising the page can be determined as an advertisement to be displayed on the page.

The invention of claim 12 is the information processing device according to claim 9,

wherein the determining means determines an advertisement of a highly ranked commodity of which the number of times of reading is large among commodities read before the date and time of the registration of an article including the keyword in the web site, as an advertisement to be displayed in the advertisement display area, with high priority.

According to this invention, an advertisement according to the intention of the supervisor supervising the page can be determined further as an advertisement to be displayed on the page.

The invention of claim 13 is the information processing device according to any one of claims 1 to 3,

wherein the determining means determines an advertisement of a commodity that has been linked by the supervisor and has been purchased by a purchaser through the link among advertisements corresponding to the keyword, as an advertisement to be displayed in the advertisement display area, with high priority.

According to this invention, an advertisement according to the intention of the supervisor supervising the page can be further determined as an advertisement to be displayed on the page.

The invention of claim 14 is the information processing device according to claim 13,

wherein the determining means determines an advertisement of a highly ranked commodity of which the number of purchases is large among commodities that have been linked by the supervisor and have been purchased by a purchaser through the link, as an advertisement to be displayed in the advertisement display area, with high priority.

According to this invention, an advertisement according to the intention of the supervisor supervising the page can be further determined as an advertisement to be displayed on the page.

The invention of claim 15 is the information processing device according to claim 13,

wherein the determining means determines an advertisement of a highly ranked commodity of which an increasing rate of the number of purchases within a latest past predetermined period is high among commodities that have been linked by the supervisor and have been purchased by a purchaser through the link, as an advertisement to be displayed in the advertisement display area, with high priority.

According to this invention, an advertisement according to the intention of the supervisor supervising the page can be further determined as an advertisement to be displayed on the page.

The invention of claim 16 is the information processing device according to any one of claims 1 to 3,

wherein the determining means determines an advertisement to be displayed in the advertisement display area, among advertisements corresponding to the keyword, based on evaluations made by the supervisor for commodities purchased by the supervisor.

According to this invention, an advertisement according to the intention of the supervisor supervising the page can be determined as an advertisement to be displayed on the page.

The invention of claim 17 is the information processing device according to claim 16,

wherein the determining means determines a highly ranked advertisement of a commodity of which the evaluation is high among the commodities evaluated by the supervisor, as an advertisement to be displayed in the advertisement display area, with high priority.

According to this invention, an advertisement according to the intention of the supervisor supervising the page can be further determined as an advertisement to be displayed on the page.

The invention of claim 18 is the information processing device according to claim 16,

wherein the determining means excludes a lowly ranked commodity of which the evaluation is low among the commodities evaluated by the supervisor, from a determination target.

According to this invention, an advertisement according to the intention of the supervisor supervising the page can be further determined as an advertisement to be displayed on the page.

The invention of claim 19 is the information processing device according to any one of claims 1 to 18,

wherein the determining means determines an advertisement to be displayed in the advertisement display area, based on the history information of a reference range set for each commodity classification.

According to this invention, an advertisement of a commodity in an appropriate range for each commodity classification can be determined as an advertisement to be displayed in the advertisement display area.

The invention of claim 20 is the information processing device according to claims 19,

wherein the reference range is a range corresponding to a working life set for each commodity classification.

According to this invention, an advertisement of a commodity exceeding the working life can be determined as an advertisement to be displayed in the advertisement display area.

The invention of claim 21 is the information processing device according to claims 19,

wherein the reference range is a range corresponding to season information set for each commodity classification.

According to this invention, an advertisement of a commodity that is appropriate for the season in which the current date and time is included can be determined as an advertisement to be displayed in the advertisement display area.

The invention of claim 22 is an information processing method executed by a computer, the information processing method comprising:

a first acquisition step of acquiring a keyword specified from a page, on which an advertisement display area used for displaying an advertisement is arranged, and which is displayable on a display screen of a terminal device;

a second acquisition step of acquiring history information of a supervisor supervising the page; and

a determination step of determining an advertisement to be displayed in the advertisement display area of the page, based on the keyword acquired in the first acquisition step and the history information acquired in the second acquiring means, from a storing means storing information of a plurality of advertisements.

The invention of claim 23 is an information processing program causing a computer to serve as:

a first acquiring means that acquires a keyword specified from a page, on which an advertisement display area used for displaying an advertisement is arranged, and which is displayable on a display screen of a terminal device;

a second acquiring means that acquires history information of a supervisor supervising the page; and

a determining means that determines an advertisement to be displayed in the advertisement display area of the page, based on the keyword acquired by the first acquiring means and the history information acquired by the second acquiring means, from a storing means storing information of a plurality of advertisements.

### Advantageous Effects of the Invention

According to the present invention, advertisements according to the intension of a supervisor supervising a page can be determined as advertisements to be displayed on the page.

### BRIEF DESCRIPTION OF THE DRAWINGS

FIG. 1 is a diagram that illustrates an example of the schematic configuration of an information providing system S according to this embodiment.

FIG. 2 is a diagram that illustrates an example of a web page on which article display areas and advertisement display areas are arranged.

FIG. 3A is a block diagram that illustrates an example of the schematic configuration of an advertisement processing server 2 according to this embodiment, and FIG. 3B is a diagram that illustrates an example of functional blocks of a system control unit 54.

FIG. 4 is a flowchart that illustrates an example of an advertisement providing process executed by a system control unit 24 of the advertisement processing server 2.

FIG. 5 is a diagram that illustrates the manner of acquiring page supervisor's history information from a history database 222.

FIG. 6 is a diagram that illustrates an example of a list of display target candidates selected from an advertisement database 221.

FIG. 7A to FIG. 7C are diagrams that illustrate the manner of rearranging the display ranks of display target candidates.

### MODE FOR CARRYING OUT THE INVENTION

Hereinafter, an embodiment of the present invention will be described with reference to the drawings. The embodiment described below is an embodiment of a case where the present invention is applied to an information providing system.

### [1. Configuration and Outline Function of Information Providing System]

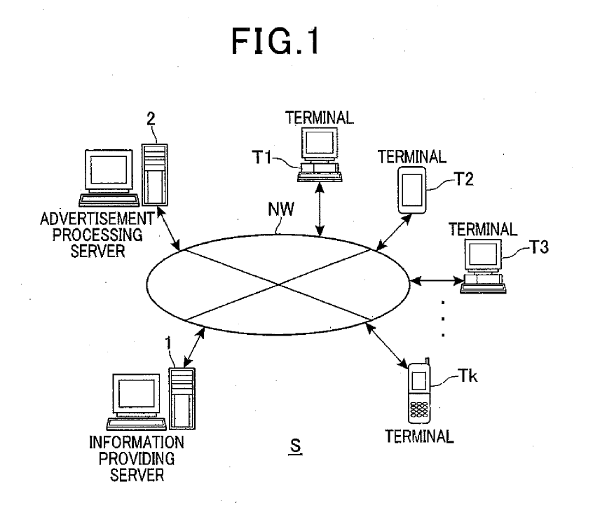

First, the configuration and the outline function of an information providing system S according to this embodiment will be described with reference to FIG. 1. FIG. 1 is a diagram that illustrates an example of the schematic configuration of the information providing system S according to this embodiment. As illustrated in FIG. 1, the information providing system S is configured to include an information providing server 1, and an advertisement processing server 2. The advertisement processing server 2 is an example of an information processing device according to the present invention. The information providing server 1 and the advertisement processing server 2 are connected to a network NW. The network NW, for example, is built by the Internet, a dedicated communication line (for example, a community antenna television (CATV) line), a mobile communication network (including a base station and the like), a gateway, and the like. In addition, terminals Tn (n=1, 2, 3, . . . , k) are connectable to the information providing server 1 and the advertisement processing server 2 through the network NW. Furthermore, as the terminals Tn, for example, terminal devices such as a personal computer (PC), a mobile phone, a personal digital assistant (PDA), a smartphone combining a mobile phone and a mobile information terminal, and a mobile game device can be used. In addition, as users using the terminals Tn, there are a page supervisor to be described later, a reader, an advertiser, and the like.

The information providing server 1 is a server that provides a web site such as a blog site or a social networking service (SNS) site. A web site is assigned to each of a plurality of users, and a unique uniform resource locator (URL) is assigned thereto. In a web site, an article that can be displayed on a web page provided for the terminal Tn is registered. The article, for example, is configured by text data. A user to whom a web site is assigned serves as a supervisor (hereinafter, referred to as a “page supervisor”) supervising a web page provided from the web site. For example, an establisher (user) establishing a web site by executing predetermined procedures through a terminal Tn corresponds to the page supervisor. In addition, other than the establisher of a web site, for example, a user using a blog site that is provided by an operator of the blog site corresponds to the page supervisor. However, a web site that provides a web page including articles registered by a plurality of users such as a bulletin board is not the target for the application of the present invention.

A web page provided from the web site is configured by a structured document such as a hypertext markup language (HTML) document or an XHTML document, image data, and the like. Among web pages, there are web pages each having a tag assigned for classifying and searching information handled in the web page embedded therein (described in the HTML document). The tag, for example, represents a category of a commodity (item) or the like. By designating a URL of a web site using a web browser, the terminal Tn displays a web page provided from the web site on a display screen (window screen) represented on a display. Accordingly, a page supervisor of the web site or a reader other than the page supervisor of the web site can read information displayed on the web page. In such a web page, at least, an article display area used for displaying (describing) an article registered by the page supervisor of the web site and an advertisement display area used for displaying an advertisement of a commodity is arranged. Here, commodities refer to targets for transactions and include not only goods but also services and the like. In the services, various services such as a facility accommodation service and a use service are included. In the advertisement display area, a script for requesting the advertisement processing server 2 to distribute an advertisement, acquiring an advertisement (advertisement data) from the advertisement processing server 2, and embedding the advertisement in the advertisement display area is set. This script is configured using a predetermined script language (for example, JavaScript (registered trademark)) and is described inside a structured document configuring a web page. The advertisement provided from the advertisement processing server 2, for example, is configured by text data, image data, or the like. In addition, in the advertisement, a link (hyperlink) to a web site providing information of a commodity or a web site executing commodity order processing is set.

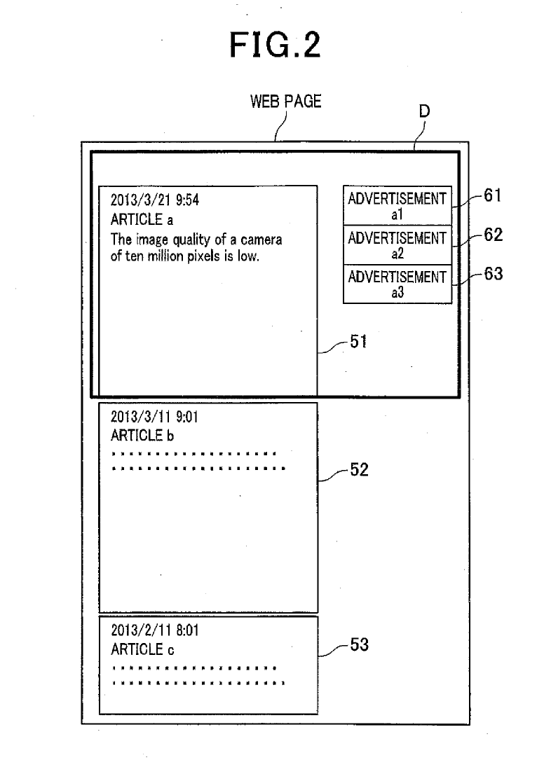

FIG. 2 is a diagram that illustrates an example of a web page on which article display areas and advertisement display areas are arranged. In the example illustrated in FIG. 2, on the web page, a plurality of article display areas 51 to 53 and a plurality of advertisement display areas 61 to 63 are arranged. With each of the article display areas 51 to 53, registration date and time of an article displayed in the corresponding article display area is associated. As the registration date and time of an article is newer, the article is displayed in the article display area disposed on a further upper portion (a position displayed first) of the web page. More specifically, among articles a to c included in the web page illustrated in FIG. 2, the article a of which the registration date and time is the newest is displayed in the article display area 51 disposed in the uppermost portion of the web page. In addition, the article b of which the registration date and time is second newest is displayed in the article display area 52 disposed in a second uppermost portion of the web page, and the article c of which the registration date and time is third newest is displayed in the article display area 53 disposed in a third uppermost portion of the web page. In the example illustrated in FIG. 2, while the advertisement display areas 61 to 63 are adjacently arranged, the advertisement display areas 61 to 63 may be arranged at arbitrary display positions. In addition, as illustrated in FIG. 2, an area of the web page that cannot be completely fit into a display screen D of the terminal Tn is displayed on the display screen D as the screen is scrolled according to a scrolling operation executed by a registrant (page supervisor), a reader, or the like of the article. Accordingly, each of the article display areas 51 to 53 and the advertisement display areas 61 to 63 can be switched between an active state and a non-active state on the display screen D. Here, the active state represents a state of being displayed on the display screen D. An article display area that is in the active state can receive an article input by a registrant (page supervisor) of the article. Then, the article input by the registrant (page supervisor) of the article is registered in the web site providing the web page and is displayed in the article display area. In addition, the advertisement display area that is in the active state can receive a selection of an advertisement that is executed by the reader. In a case where an advertisement is selected by a reader, for example, a web page on which the information of a commodity is placed is displayed according to a link set in the selected advertisement. In addition, an area of the web page that cannot be completely fit into the inside of the display screen D of the terminal Tn may be configured to be acquired each time from the information providing server 1 according to a scrolling operation, for example, by using the technology of Ajax.

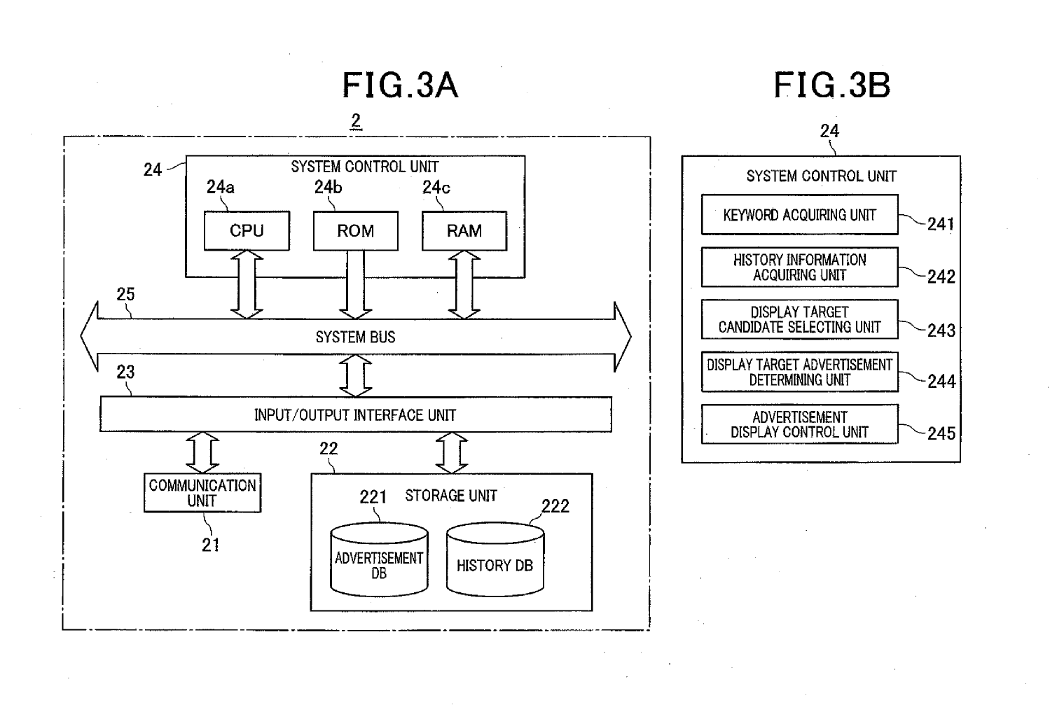

FIG. 3A is a block diagram that illustrates an example of the schematic configuration of the advertisement processing server 2 according to this embodiment. As illustrated in FIG. 3A, the advertisement processing server 2 includes a communication unit 21, a storage unit 22 (an example of a storing means), an input/output interface unit 23, and a system control unit 24. The system control unit 24 and the input/output interface unit 23 are connected through a system bus 25. The communication unit 21 is connected to the network NW and controls the communication state.

The storage unit 22, for example, is configured by a hard disk drive or the like and stores various programs such as an operating system and an advertisement providing process program (including an information processing program according to the present invention). In addition, the advertisement providing process program, for example, may be downloaded from a predetermined server or the like through the network NW or may be recorded (recorded to be readable by using a computer) on a recording medium such as a compact disc (CD) or a digital versatile disc (DVD) and be read. Furthermore, in the storage unit 22, for example, an advertisement (advertisement data) provided from an advertiser is stored in association with an advertisement ID (an advertisement ID of the advertisement) identifying the advertisement.

In addition, in the storage unit 22, an advertisement database (DB) 221, a history database (DB) 222, and the like are arranged. Here, such databases may be configured not to be arranged in the storage unit 22 but to be arranged in a server other than the advertisement processing server 2. In the advertisement database 221, an advertisement ID of an advertisement, an advertiser ID (an advertiser ID of an advertiser) identifying an advertiser, a bid amount of the advertisement, and commodity information of a commodity that is an advertisement target are registered in association with each other. Such information is an example of information of an advertisement. Here, the bid amount of an advertisement represents an amount designated by the advertiser for displaying the advertisement in an advertisement display area. In a case where the number of advertisement requests from advertisers is more than the number of advertisement display areas, as the bid amount of an advertisement is higher, the advertisement may be determined more easily as an advertisement to be displayed in a corresponding advertisement display area. In addition, in the commodity information of a commodity that is an advertisement target, a commodity ID (a commodity ID of a commodity) identifying a commodity, a commodity classification of the commodity, and the like are included in association with each other.

Here, the commodity ID is an example of commodity specifying information that uniquely specifies a commodity. The commodity specifying information may be information other than the commodity ID (for example, a commodity code or the like) as long as the information can be used for uniquely specifying a commodity. The commodity classification of a commodity, for example, represents a category of the commodity. As examples of the commodity classification, there are “camera”, “television set”, “washer”, “refrigerator”, and the like. In addition, the commodity classification may be configured to be classified into a plurality of hierarchies from a higher hierarchy (higher level) to a lower hierarchy (lower level). For example, the commodity classification is classified into hierarchies in which a level 1 (the highest level) is “electric appliance”, a level 2 is “camera”, a level 3 is “compact camera”, and a level 4 (lowest level) is “manufacturer”. Alternatively, the commodity classification is classified into hierarchies in which a level 1 (the highest level) is “electric appliance”, a level 2 is “home electric appliance”, a level 3 is “washer”, and a level 4 (lowest level) is “manufacturer”. Alternatively, the commodity classification is classified into hierarchies in which a level 1 (the highest level) is “fashion”, a level 2 is “men's fashion”, a level 3 is “tops”, a level 4 is “cardigan”, and a level 5 (lowest level) is “manufacturer”. In addition, the commodity information may include working life or season information. For example, “15 years” is set to “camera” as the working life, and “20 years” is set to “washer” as the working life. The season information, particularly, is set to a commodity classification of a low level (for example, the level “4”). For example, “winter (November to March)” is set to “cardigan” as the season information.

In the history database 222, history information of a page supervisor is registered for each page supervisor. The history information of a page supervisor, for example, includes at least one of a purchase history, a reading history, a review post history, and an affiliated history. Here, the purchase history, for example, includes information of a user ID (a user ID of the page supervisor) used for identifying the page supervisor, a commodity ID of a commodity purchased by the page supervisor, a commodity classification of the commodity, purchase date and time of the commodity, and the like. The reading history, for example, includes information of a user ID of a page supervisor, a commodity ID of a commodity read by the page supervisor through the web site, a commodity classification of the commodity, reading date and time of the commodity, and the like. In addition, the reading history, for example, includes a registration history of commodities registered in a watch list by the page supervisor as well. The review post history, for example, includes information of a user ID of a page supervisor, a commodity ID of a commodity reviewed by the page supervisor, a content of the review, a commodity classification of the commodity, review date and time of the commodity, and the like. In addition, the review includes an evaluation, which is made by the page supervisor, of a commodity purchased by the page supervisor. This evaluation, for example, is represented by a review score, and, as the review score is higher, the evaluation for the commodity is more highly rated. The affiliated history (customer sending-off result), for example, includes information of a user ID of a page supervisor, a commodity ID of a commodity purchased through an affiliation by a purchaser other than the page supervisor, a commodity classification of the commodity, purchase date and time of the commodity, and the like. The affiliated purchase, for example, represents that a commodity, which is affiliation-linked by the page supervisor, is purchased by a purchaser through the link and the like. In a case where the affiliated purchase is satisfied, a result reward for the affiliation is paid to the page supervisor.

The history information described above, for example, is acquired at predetermined timing from various web sites such as a shopping site, an auction site, a service reservation site, and a blog site by using a user ID of a page supervisor or information that can be used for identifying a page supervisor as a key and is accumulated in the history database 222.

The system control unit 24 is configured by a central processing unit (CPU) 24a, a read only memory (ROM) 24b, a random access memory (RAM) 24c, and the like. FIG. 3B is a diagram that illustrates an example of functional blocks of the system control unit 54. The system control unit 24 as a computer executes an advertisement providing process according to the advertisement providing process program stored in the storage unit 22. In such an advertisement providing process, the system control unit 24, as illustrated in FIG. 3B, serves as a keyword acquiring unit 241, a history information acquiring unit 242, a display target candidate selecting unit 243, a display target advertisement determining unit 244, an advertisement display control unit 245, and the like. Here, the keyword acquiring unit 241 is an example of a first acquiring means according to the present invention. The history information acquiring unit 242 is an example of a second acquiring means according to the present invention. In addition, the display target candidate selecting unit 243 is an example of a selecting means according to the present invention. The display target advertisement determining unit 244 is an example of a determining means according to the present invention.

The keyword acquiring unit 241 acquires a keyword that is specified from a web page in which the advertisement display areas described above are arranged. Here, the keyword, for example, is a word that represents the category of a commodity.

The history information acquiring unit 242 acquires history information of a page supervisor of a web page that is an acquisition source of a keyword acquired by the keyword acquiring unit 241 from the history database 222. The history information of the page supervisor, for example, can be acquired by using the user ID of the page supervisor as a key.

The display target candidate selecting unit 243 selects advertisements corresponding to the keyword acquired by the keyword acquiring unit 241 from the advertisement database 221 as display target candidates. For example, advertisements of a commodity belonging to a commodity classification including the keyword are selected from the advertisement database 221.

The display target advertisement determining unit 244 determines advertisements to be displayed in the advertisement display areas of the web page among advertisements selected by the display target candidate selecting unit 243 based on the history information acquired by the history information acquiring unit 242 (an advertisement determining process based on the history). For example, the display target advertisement determining unit 244 determines advertisements corresponding to the number of advertisement display areas arranged on the web page. In addition, in a case where the number of display target candidates selected by the display target candidate selecting unit 243 is more than the number of advertisement display areas, the display target advertisement determining unit 244, for example, determines display target candidates of higher bid amounts of advertisements or higher scores of advertisements as advertisements to be displayed in the advertisement display areas. Here, the score of an advertisement is calculated based on a keyword acquired by the keyword acquiring unit 241. For example, as an advertisement includes more keywords, the score thereof is higher. In addition, the score of an advertisement may be calculated by using a technique that is used when a search result is sorted and displayed using a general search engine. In this embodiment, while the display target advertisement determining unit 244 is configured to determine advertisements to be displayed in the advertisement display areas of the web page among advertisements selected by the display target candidate selecting unit 243, the display target advertisement determining unit 244 may be configured to determine advertisements to be displayed in the advertisement display areas of the web page based on a keyword acquired by the keyword acquiring unit 241 from the advertisement database 221 and history information acquired by the history information acquiring unit 242. In such a case, the display target candidate selecting unit 243 may not be arranged.

The advertisement display control unit 245 supplies (transmits) the advertisements of commodities determined by the display target advertisement determining unit 244 to the web browser of the terminal Tn, thereby displaying the advertisements in the advertisement display areas of the web page.

In addition, the system control unit 24 has a function of receiving an advertisement bid through the terminal Tn of the advertiser and registering information relating to the bid advertisement in the advertisement database 221 in addition to the functions described above.

### [2. Operation of Information Providing System S]

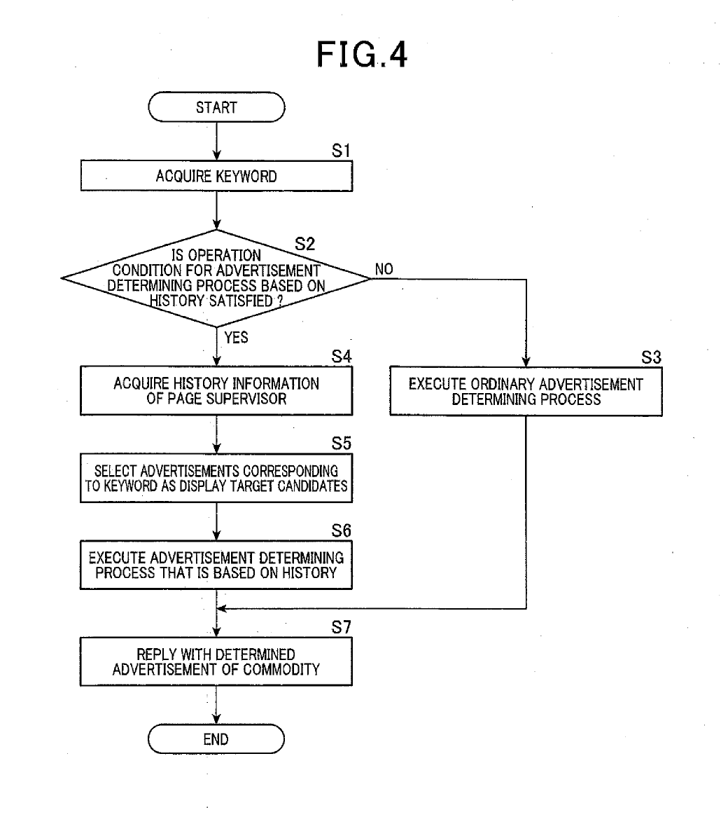

Next, an example of the operation of the information providing system S according to this embodiment will be described with reference to FIG. 4. FIG. 4 is a flowchart that illustrates an example of the advertisement providing process executed by the system control unit 24 of the advertisement processing server 2. The process illustrated in FIG. 4, for example, is started in a case where the advertisement processing server 2 receives an advertisement distribution request transmitted from the terminal Tn through the network NW is received.

In addition, when a web page acquired from the information providing server 1 is displayed, the web browser of the terminal Tn executes a script embedded in the advertisement display areas of the web page, thereby acquiring articles described in predetermined article display areas. Then, the web browser accesses the advertisement processing server 2 through the network NW based on address information of the advertisement processing server 2 and transmits an advertisement distribution request to the advertisement processing server 2. In this advertisement distribution request, for example, an article (an article registered by the page supervisor) acquired by the web browser, the registration date and time of the article, the user ID of the page supervisor of the web page, and the number (hereinafter, referred to as “advertisement display area number”) of advertisement display areas disposed on the web page are included. Here, the user ID of the page supervisor is acquired by the web browser of the terminal Tn, for example, when the page supervisor logins. In addition, in a case where a plurality of article display areas are arranged on the web page, articles described in all the article display areas and the registration date and time of the articles may be configured to be included in the advertisement distribution request. Alternatively, in such a case, an article (in other words, a latest article) described in the article display area associated with the latest registration date and time or an article described in the article display area that is in the active state may be configured to be included in the advertisement distribution request.

When the process illustrated in FIG. 4 is started, the keyword acquiring unit 241 of the system control unit 24 acquires a keyword from the received advertisement distribution request (step S1). At this time, the user ID of the page supervisor, the advertisement display area number, and the registration date and time of the article are acquired as well. The keyword acquiring unit 241, for example, acquires a keyword matching the commodity classification registered in a commodity classification list prepared in advance from the article included in the advertisement distribution request. In this article, there are cases where an evaluation (for example, “ . . . camera has a bad image quality” or the like) made by the page supervisor for the keyword is included. In addition, this article, for example, is a latest article or an article described in the article display area that is in the active state. In addition, in a case where a plurality of articles are included in the advertisement distribution request, for example, a keyword is acquired from an article associated with the latest registration date and time among the plurality of articles. Alternatively, in such a case, for example, among the plurality of articles, it may be configured such that a keyword is acquired from an article including more commodity IDs that appear more in the plurality of articles.

In addition, the keyword acquiring unit 241 may be configured to acquire keyword, which is extracted from the article by the web browser of the terminal Tn, from the terminal Tn. Alternatively, the keyword acquiring unit 241 may be configured to acquire a tag, which is extracted from the web page by the web browser of the terminal Tn, from the terminal Tn as a keyword. Alternatively, the keyword acquiring unit 241 may be configured to acquire a URL of the web page, which is acquired from the web page by the web browser of the terminal Tn, from the terminal Tn and acquire a keyword associated with the URL matching the URL registered in a URL-to-keyword association list prepared in advance.

Thereafter, the system control unit 24 determines whether or not the keyword acquired in step S1 satisfies the operation condition for the advertisement determining process based on the history of the page supervisor (step S2). For example, in a case where the keyword acquired in step S1 represents the category of a commodity (in other words, a higher concept of the commodity), it is determined that the operation condition for the advertisement determining process that is based on the history is satisfied. In other words, in a case where the keyword is not a specific commodity name or a commodity ID but a category of a commodity, the advertisement determining process that is based on the history of the page supervisor is operated, and an advertisement corresponding to the keyword is executed by the display target candidate selecting unit 243. The reason for this is that, in a case where the keyword is not a specific commodity name or a commodity ID but a category of a commodity, when an advertisement is selected based on only the category, commodities of a broad range belonging to the category are selected, and, as a result, there is a possibility that an advertisement according to the intension of the page supervisor cannot be selected. For this reason, in a case where the keyword represents a category of a commodity, by operating the advertisement determining process that is based on the history of the page supervisor, an advertisement according to the intension of the page supervisor can be selected. Alternatively, in a case where the evaluation made by the page supervisor for the keyword acquired in step S1 is positive, it is determined that the operation condition for the advertisement determining process that is based on the history is satisfied. In other words, in such a case, in a case where the evaluation made by the page supervisor for the keyword is negative, an advertisement corresponding to the keyword is not selected by the display target candidate selecting unit 243. The reason for this is that, in a case where the evaluation made by the page supervisor for the keyword is negative, even when advertisements corresponding to the keyword are selected as display target candidates based on the history information of the page supervisor, there is a possibility that an advertisement according to the intension of the page supervisor cannot be selected. Here, a determination on whether or not the evaluation made by the page supervisor is positive, for example, is executed by referring to evaluation words registered in an evaluation word list prepared in advance. In the evaluation words, positive words such as “good” or “light” and negative words such as “bad” and “heavy” are included. In a case a word included in the article that is associated with the keyword is a positive word, it is determined that the evaluation made by the page supervisor is positive.

Then, in a case where it is determined that the keyword does not satisfy the operation condition for the advertisement determining process that is based on the history (No in step S2), the process proceeds to step S3. On the other hand, in a case where it is determined that the keyword satisfies the operation condition for the advertisement determining process that is based on the history (Yes in step S2), the process proceeds to step S4. In other words, in a case where the keyword acquired in step S1 represents a category of a commodity or in a case where the evaluation made by the page supervisor for the keyword is positive, an advertisement corresponding to the keyword is determined by the process of step S4 and subsequent steps. In step S3, the system control unit 24 executes an ordinary advertisement determining process that is not based on the history. In this advertisement determining process, for example, a highly ranked advertisement of which the bid amount is large is determined as an advertisement to be displayed in the advertisement display area, and the process proceeds to step S7.

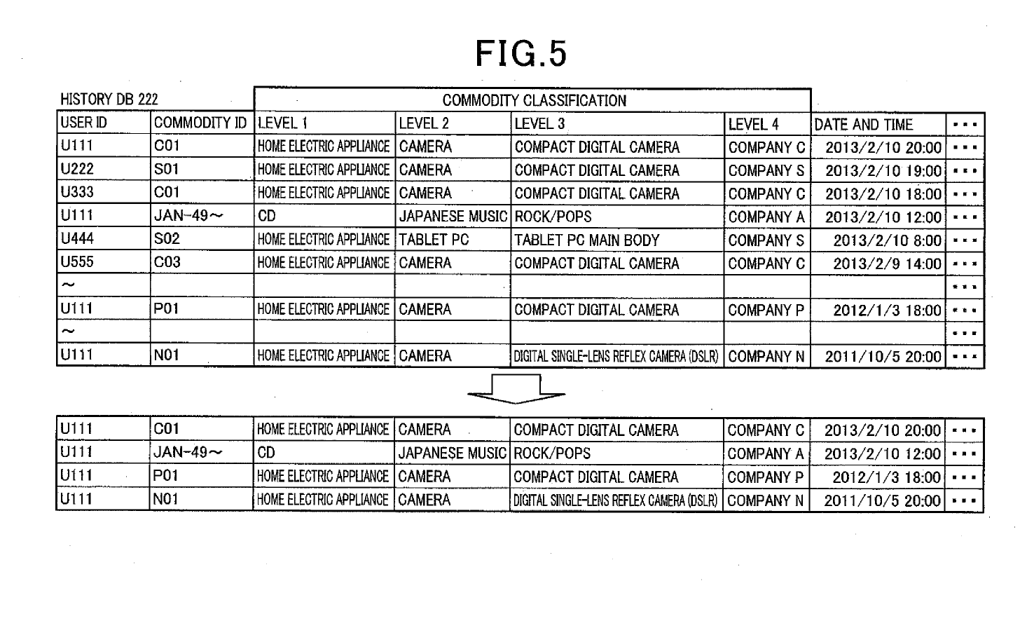

In step S4, the history information acquiring unit 242 of the system control unit 24, for example, acquires history information in which the user ID (the user ID of the page supervisor) is included by using the user ID acquired in step S1 as a key from the history database 222 as the history information of the page supervisor. FIG. 5 is a diagram that illustrates the manner of acquiring page supervisor's history information from the history database 222. In the example illustrated in FIG. 5, history information corresponding to four records in which the user ID “U111” is included is acquired.

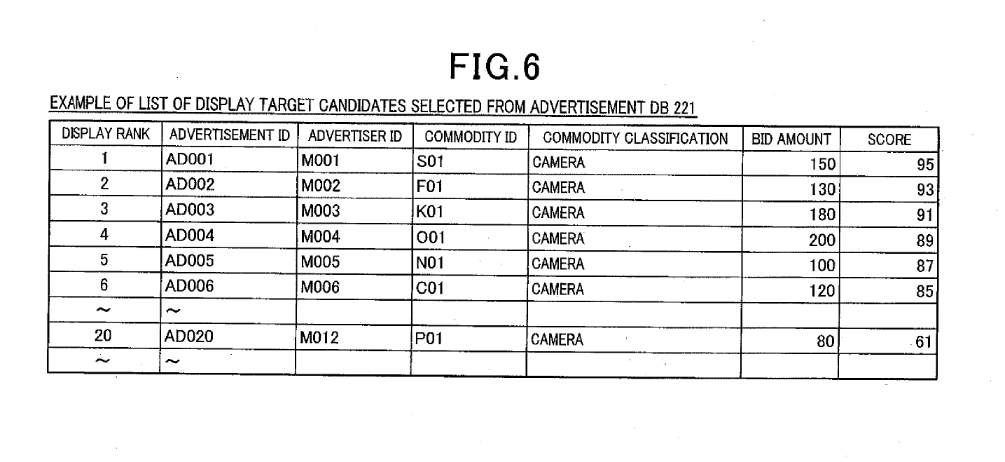

Thereafter, the display target candidate selecting unit 243 of the system control unit 24 selects advertisements corresponding to the keyword acquired in step S1 from the advertisement database 221 as display target candidates (step S5). FIG. 6 is a diagram that illustrates an example of the list of display target candidates selected from the advertisement database 221. In the example illustrated in FIG. 6, the selected display target candidates are advertisements of commodities belonging to a commodity classification including the acquired keyword. In the list illustrated in FIG. 6, in addition to the advertisement ID, the advertiser ID, the commodity ID, the commodity classification, and the bid amount of the advertisement, the score of the advertisement and the display rank of the advertisement are illustrated. In the example illustrated in FIG. 6, while the display rank of the advertisements is in order of highest to lowest score of the advertisement, the display rank may be in order of highest to lowest bid amount of the advertisement.

Thereafter, the display target advertisement determining unit 244 of the system control unit 24 executes the advertisement determining process that is based on the history (step S6). There are examples of the advertisement determining process based on the history as illustrated in the following (a) to (d).

### (a) Advertisement Determining Process Based on Purchase History of Page Supervisor

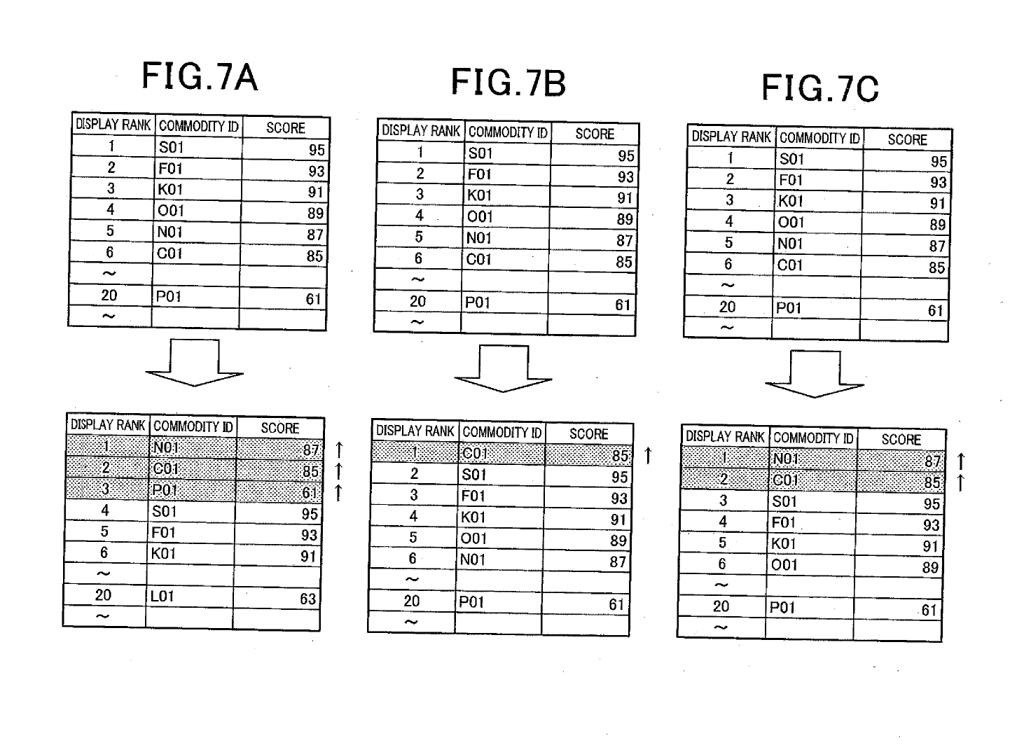

In this case, the display target advertisement determining unit 244 determines advertisements of commodities purchased by the page supervisor with high priority as advertisements to be displayed in the advertisement display areas based on the purchase history included in the history information acquired in step S4 from among the display target candidates (in other words, advertisements corresponding to the keyword) selected in step S5. For example, the display target advertisement determining unit 244 makes rearrangement such that display ranks of the display target candidates corresponding to the advertisement IDs associated with the commodity IDs included in the acquired purchase history are high and then determines highly ranked advertisements of high display ranks (corresponding to the number of the advertisement display areas acquired in step S1). FIG. 7 is a diagram that illustrates the manner of rearranging the display ranks of display target candidates. Among these, in the example illustrated in FIG. 7A, advertisements of three commodities (commodity IDs: “N01”, “C01”, and “P01”) purchased by the page supervisor are caused to have high priority, and the display ranks thereof are changed to higher ranks. According to such a configuration, advertisements according to the intension of the page supervisor can be determined as advertisements to be displayed on the web page.

Here, it is preferable that the commodities purchased by the page supervisor are commodities purchased before the registration date and time of the article including the keyword. The reason for this is that, on the article of such a case, the intension of the page supervisor for the commodity purchased by the page supervisor is considered to be reflected. Whether a commodity has been purchased before the registration date and time of the article including the keyword is determined by comparing the purchase date and time of the commodity included in the purchase history acquired in step S4 with the registration date and time acquired in step S1. In addition, depending on the reading timing of a reader of a web page on which an advertisement is displayed, since there is a case where the advertisement of the commodity purchased by the page supervisor is displayed after the registration of the article, in other words, a case where the information of a purchased commodity is reflected on the history database 222 after the registration of the article, there are cases where the commodity purchased by the page supervisor is a commodity purchased after the registration date and time of the article including the keyword.

In addition, the display target advertisement determining unit 244 may be configured to specify an advertisement of a commodity purchased within a predetermined period (for example, within one month) before the registration date and time of the article including the keyword acquired in step S1 in the web site and determine the specified advertisement with high priority. In the example illustrated in FIG. 7B, in a case where the registration date and time of the article is “2013/2/2 10:00”, an advertisement of one commodity (the commodity ID: “C01”) purchased by the page supervisor within one month before the registration date and time has high priority, and the display rank thereof is changed to a higher rank. According to such a configuration, an advertisement according to the latest intension (a taste or the like) of the page supervisor can be determined as an advertisement to be displayed on the web page. Alternatively, the display target advertisement determining unit 244 may be configured to determine an advertisement of a commodity, of which the purchase date and time is closest to the registration date and time, with high priority among commodities purchased before the registration date and time of the article including the keyword acquired in step S1 in the web site. According to such a configuration, advertisements according to the latest intension of the page supervisor can be determined as advertisements to be displayed on the web page.

### (b) Advertisement Determining Process Based on Reading History of Page Supervisor

In this case, the display target advertisement determining unit 244 determines advertisements of commodities read by the page supervisor with high priority as advertisements to be displayed in the advertisement display areas based on the reading history included in the history information acquired in step S4 from among the display target candidates (in other words, advertisements corresponding to the keyword) selected in step S5. For example, the display target advertisement determining unit 244 makes rearrangement such that display ranks of the display target candidates corresponding to the advertisement IDs associated with the commodity IDs included in the acquired reading history are high and then determines highly ranked advertisements of high display ranks (corresponding to the number of the advertisement display areas acquired in step S1). According to such a configuration, advertisements according to the intension of the page supervisor can be determined as advertisements to be displayed on the web page.

Here, it is preferable that the commodities read by the page supervisor are commodities read before the registration date and time of the article including the keyword. The reason for this is the same as that of the case of the commodities purchased by the page supervisor. Whether a commodity has been read before the registration date and time of the article including the keyword is determined by comparing the reading date and time of the commodity included in the reading history acquired in step S4 with the registration date and time acquired in step S1. In addition, from the same reason as that of the case of the commodities purchased by the page supervisor, there are cases where the commodity read by the page supervisor is a commodity read after the registration date and time of the article including the keyword.

In addition, the display target advertisement determining unit 244 may be configured to specify an advertisement of a commodity read within a predetermined period (for example, within one week) before the registration date and time of the article including the keyword acquired in step S1 in the web site and determine the specified advertisement with high priority. According to such a configuration, an advertisement according to the latest intension (a taste or the like) of the page supervisor can be determined as an advertisement to be displayed on the web page. Alternatively, the display target advertisement determining unit 244 may be configured to determine an advertisement of a commodity, of which the reading date and time is closest to the registration date and time, with high priority among commodities read before the registration date and time of the article including the keyword acquired in step S1 in the web site. According to such a configuration, advertisements according to the latest intension of the page supervisor can be determined as advertisements to be displayed on the web page. Alternatively, the display target advertisement determining unit 244 may be configured to determine advertisements of highly ranked commodities, of which the number of times of reading is large, with high priority from among commodities read before the registration date and time of the article including the keyword acquired in step S1 in the web site. Since such commodities can be regarded as commodities attracting the page supervisor's attention, advertisements according to the intension of the page supervisor can be further determined as advertisements to be displayed on the web page. Here, the number of times of reading of a commodity can be acquired by summing the number of records including the same commodity ID among records representing the reading history of commodities read before the registration date and time. Alternatively, the display target advertisement determining unit 244 may be configured to determine advertisements of highly ranked commodities of which the number of times of reading is large with high priority from among commodities that have been read before the registration date and time of the article including the keyword acquired in step S1 in the web site. Such commodities can be regarded as commodities attracting the attention of the page supervisor as well. Here, the number of times of reading of a commodity, for example, is a sum of display times of the commodity published on a webpage. This display time, for example, is measured by a web browser. The measured display time, for example, is transmitted at arbitrary timing to the advertisement processing server 2 together with the commodity ID and the like and is registered in the history database 222 as a reading history.

### (c) Advertisement Determining Process Based on Review Post History of Page Supervisor

In this case, the display target advertisement determining unit 244 determines advertisements to be displayed in the advertisement display areas based on the review post history included in the history information acquired in step S4 from among the display target candidates (in other words, advertisements corresponding to the keyword) selected in step S5. For example, the display target advertisement determining unit 244 acquires evaluations (review scores) made by the supervisor for commodities purchased by the page supervisor from reviews included in the acquired review post history. Then, the display target advertisement determining unit 244 makes rearrangement such that display ranks of display target candidates of a commodity (in other words, the display target candidates corresponding to an advertisement ID associated with a commodity ID of the commodity) of which the evaluations are highly ranked are high and then determines advertisements of the highly ranked commodity of which the display rank is high (corresponding to the advertisement display area number acquired in step S1). In other words, among commodities for which the evaluations have been made by the page supervisor, advertisements of a highly ranked commodity of which the evaluation is high are determined with high priority. For example, in the case of evaluations of five levels of “1” to “5”, evaluations of four or more are set to be high in advance, and evaluations of two or less are set to be low in advance. According to such a configuration, advertisements according to the intension of the page supervisor can be determined as advertisements to be displayed on the web page. In addition, the display target advertisement determining unit 244 may be configured to exclude lowly ranked commodities of which the evaluations are low from determination targets from among the commodities for which evaluations have been made by the page supervisor (for example, lowly ranked commodities of which the evaluations are low are excluded from the list of display target candidates as illustrated in FIG. 6).

### (d) Advertisement Determining Process Based on Affiliated History of Page Supervisor

In this case, the display target advertisement determining unit 244 determines advertisements to be displayed in the advertisement display areas based on the affiliated history included in the history information acquired in step S4 from among the display target candidates (in other words, advertisements corresponding to the keyword) selected in step S5. For example, the display target advertisement determining unit 244 makes rearrangement such that display ranks of display target candidates of a commodity (in other words, display target candidates corresponding to an advertisement ID with which a commodity ID of the commodity is associated) that has been affiliated-linked by the page supervisor and has been purchased through an affiliation by a purchaser through the link based on the acquired affiliation history are high and then determines advertisements of the highly ranked commodity of which the display rank is high (corresponding to the advertisement display area number acquired in step S1). In other words, advertisements of a commodity that has been affiliated-linked by the page supervisor and has been purchased through an affiliation are determined with high priority.

In addition, the display target advertisement determining unit 244 may be configured to determine advertisements of a highly ranked commodity of which the number of purchases made through affiliations with high priority from among commodities that have been affiliated-linked by the page supervisor and have been purchased through the affiliations. Since such commodities can be regarded as commodities purchased through recommendation efforts of the page supervisor in the article, advertisements according to the intension of the page supervisor can be determined further as advertisements to be displayed on the web page. Here, the number of purchases of a commodity through an affiliation, for example, can be acquired by summing the number of records including the same commodity ID among records representing the affiliation history. Alternatively, the display target advertisement determining unit 244 may be configured to determine advertisements of highly ranked commodities of which the increasing rate of the purchases within a latest past predetermined period (for example, within one month) is high from among commodities that have been affiliated-linked by the page supervisor and have been purchased through affiliations with high priority. According to such a configuration, advertisements according to the intension of the page supervisor can be further determined as advertisements to be displayed on the web page.

Any one of the advertisement determining processes that are based on the histories illustrated in (a) to (d) described above may be configured to be executed, or two or more of the advertisement determining processes may be configured to be individually executed (for example, executed according to an “OR” condition).

In addition, the display target advertisement determining unit 244 may be configured to determine advertisements, of which the scores satisfy a predetermined condition, with high priority from among the display target candidates selected in step S5 as advertisements to be displayed in the advertisement display areas. For example, the display target advertisement determining unit 244 finally determines advertisements, of which the advertisement scores satisfy a predetermined condition, determined with high priority by the advertisement determining process that is based on the history described above as advertisements to be displayed in the advertisement display areas. Here, as the advertisements of which the scores satisfy the predetermined condition, for example, there are (1) advertisements of which the scores have differences of a threshold or less from a highest score from among the display target candidates selected in step S5, (2) advertisements of which the scores have differences of a threshold or less from the average of the scores of advertisements corresponding to the number of the advertisement frames (advertisement display areas) starting from the display target candidate of which the advertisement score rank is high among the display target candidates selected in step S5, and (3) advertisements of which the advertisement score ranks have differences of a threshold (for example, 20) or less from the lowest score (for example, an advertisement having a third score of the scores of three advertisement frames) of the scores of advertisements corresponding to the number of the advertisement frames (advertisement display areas) starting from the display target candidate of which the advertisement score rank is high among the display target candidates selected in step S5. In the example illustrated in FIG. 7C, the case of “(3)” described above represents the rearrangement. In such a case, an advertisement of a commodity (commodity ID: “P01”) of which the advertisement score has a difference larger than a threshold (for example 20) from the lowest score “91” (the commodity ID “K01”) of the scores of advertisements corresponding to the number of the advertisement frames starting from the display target candidate of which the advertisement score rank is high is not caused to have high priority, and the display rank thereof is not changed to a higher rank. According to such a configuration, it can be prevented that, in the display rank that is based on the advertisement scores of the display target candidates selected in step S5, a display target candidate of which the rank or the score is too far from that of the display target candidate having a high advertisement score rank is determined as an advertisement to be displayed in the advertisement display area with high priority.

In addition, the display target advertisement determining unit 244 may be configured to determine advertisements, of which the advertisement bid amounts satisfy a predetermined condition, with high priority from among the display target candidates selected in step S5 as advertisements to be displayed in the advertisement display areas. For example, the display target advertisement determining unit 244 finally determines advertisements, of which the advertisement bid amounts satisfy a predetermined condition, determined with high priority by the advertisement determining process that is based on the history described above as advertisements to be displayed in the advertisement display areas. Here, as the advertisements of which the bid amounts satisfy the predetermined condition, for example, there are (1) advertisements of which the bid amounts have differences of a threshold or less from a highest bid amount from among the display target candidates selected in step S5, (2) advertisements of which the bid amounts have differences of a threshold or less from the average of the bid amounts of advertisements corresponding to the number of the advertisement frames (advertisement display areas) starting from the display target candidate of which the bid amount rank is high among the display target candidates selected in step S5, and (3) advertisements of which the bid amounts have differences of a threshold or less from the lowest bid amount (for example, an advertisement having a third bid amount rank of the bid amounts of three advertisement frames) of the bid amounts of advertisements corresponding to the number of the advertisement frames starting from the display target candidate of which the advertisement bid amount is high among the display target candidates selected in step S5. According to such a configuration, it can be prevented that, in the display rank that is based on the advertisement bid amounts of the display target candidates selected in step S5, a display target candidate of which the rank of the advertisement bid amount is too far from that of the display target candidate having a high advertisement bid amount rank is determined as an advertisement to be displayed in the advertisement display area with high priority.

In addition, in the advertisement determining process that is based on the history, while the display target advertisement determining unit 244 is configured to determine advertisements to be displayed in the advertisement display areas of the web page based on the history information acquired in step S4, the display target advertisement determining unit 244 may be configured to limit the reference range of the history information. In such a case, the display target advertisement determining unit 244 determines advertisements to be displayed in the advertisement display areas based on the history information of the reference range set for each commodity classification. This reference range, for example, is a range corresponding to the working life set for each commodity classification. In such a case, for example, the display target advertisement determining unit 244 determines advertisements to be displayed in the advertisement display areas of the web page based on the history information corresponding to commodities of which the period from the purchase date and time to the current date and time (in other words, date and time when the process is executed) exceeds the working life set for the commodity classification corresponding to the keyword acquired in step S1. Accordingly, an advertisement of a commodity (in other words, a commodity that needs to be replaced) exceeding the working life can be determined as an advertisement to be displayed in the advertisement display area. Alternatively, the reference range, for example, is a range corresponding to the season information set for each commodity classification (particularly, the lower level). In such a case, the display target advertisement determining unit 244 determines advertisements to be displayed in the advertisement display areas of the web page based on the history information corresponding to a commodity (commodity classification) in which the current date and time (date and time when the process is executed) is included in a range (for example, November to March) appearing in the season information set for the commodity classification corresponding to the keyword set in step S1. Accordingly, an advertisement of a commodity that is appropriate for the season in which the current date and time is included can be determined as advertisements to be displayed in the advertisement display areas.

In addition, the reference range of the history information may be configured to be limited by the attribute of the commodity classification. For example, in a case where a commodity classification corresponding to the keyword acquired in step S1 is a commodity classification (for example, clothing or the like) of an attribute having a possibility that a plurality of commodities are maintained by the user, the advertisements to be displayed in the advertisement display areas of the web page are determined based on the history information by referring to the history information of each of a plurality of mutually-different commodities (commodities having mutually-different commodity IDs) belonging to the commodity classification. On the other hand, in a case where a commodity classification corresponding to the keyword acquired in step S1 is a commodity classification (for example, a refrigerator or the like) of an attribute having a low possibility that a plurality of commodities are maintained by the user, the advertisements to be displayed in the advertisement display areas of the web page are determined based on the history information, for example, by referring to the history information of only a closest commodity among commodities belonging to the commodity classification.

Then, in step S7, the advertisement display control unit 245 of the system control unit 24 replies with (transmits) the advertisement (advertisement data) determined in step S3 or S6 to the web browser of the terminal Tn, thereby displaying the advertisement in the advertisement display area. In addition, in a case where a plurality of advertisements are determined in step S3 or S6, each advertisement and information representing the display rank of the advertisement may be configured to be transmitted to the web browser of the terminal Tn. In this way, when the advertisement is acquired, the web browser of the terminal Tn displays the advertisement in the advertisement display area of the web page. In addition, in a case where a plurality of advertisements and information representing the display rank of each advertisement are acquired, the web browser of the terminal Tn displays the advertisements in the advertisement display areas according to the display rank. For example, as the display rank of an advertisement is higher, the advertisement is displayed in the advertisement display area (the advertisement display area 61 in the example illustrated in FIG. 2) arranged on the upper part of the web page.

As described above, according to the embodiment described above, in a case where an advertisement distribution request is received from the terminal Tn, the advertisement processing server 2 acquires a keyword specified from the web page displayed on the terminal Tn and acquires the history information of the page supervisor of the web page. Then, the advertisement processing server 2 is configured to select advertisements corresponding to the keyword as display target candidates from the advertisement database 221 and determine advertisements to be displayed in the advertisement display areas of the web page among the selected advertisements based on the history information of the page supervisor, whereby advertisements according to the intension of the page supervisor can be determined as advertisements to be displayed on the web page.

In the embodiment described above, while the information providing server 1 and the advertisement processing server 2 are configured as independent hardware, the function of the information providing server 1 may be configured to be embedded in the advertisement processing server 2. In such a case, in a case where there is a request for a web page from the terminal Tn, the advertisement processing server 2 embeds advertisements determined by executing the process illustrated in FIG. 4 in the advertisement display areas and transmits a web page in which the advertisements are embedded to the terminal Tn.

### REFERENCE SIGN LIST

1 Information providing server
2 Advertisement processing server
21 Communication unit
22 Storage unit
23 Input/output interface unit
24 System control unit
Tn Terminal
NW Network
S Information providing system

1. An information processing device comprising:
at least one memory operable to store computer program code;
at least one processor operable to access said program code and operate according to said program code, said program code including:
first acquiring code configured to cause at least one of said at least one processor to acquire a keyword specified from a Web page, on which an advertisement display area used for displaying an advertisement is arranged, said Web page being transmitted from a server to a terminal device through a network, and being displayed on a display screen of the terminal device;
second acquiring code configured to cause at least one of said at least one processor to acquire history information of a supervisor, from a history database which stores at least one piece of history information of purchase history, reading history, review posting history, and affiliate history of the supervisor supervising the Web page;
determining code configured to cause at least one of said at least one processor to select advertisements corresponding to the keyword acquired, from an advertisement database which stores at least advertisement ID of advertisement, and commodity information of commodity of advertisement target as each information of a plurality of advertisements, and determines, from the selected advertisements, an advertisement specified by the history information acquired, as an advertisement to be displayed in the advertisement display area of the Web page; and
advertisement display control code configured to cause at least one of said at least one processor to control the display of the advertisement determined, in an advertisement display area of the Web page.

2. The information processing device according to claim 1,
wherein, in a case where the keyword acquired represents a category of a commodity, the determining code causes at least one of said at least one processor to determine an advertisement corresponding to the keyword.

3. The information processing device according to claim 1,
wherein, in a case where an evaluation made by the supervisor for the keyword is positive, the determining code causes at least one of said at least one processor to determine an advertisement corresponding to the keyword.

4. The information processing device according to claim 1,
wherein the determining code causes at least one of said at least one processor to determine an advertisement of which a score calculated based on the keyword satisfies a predetermined condition, as an advertisement to be displayed in the advertisement display area, with high priority among advertisements corresponding to the keyword.

5. The information processing device according to claim 1,
wherein the determining code causes at least one of said at least one processor to determine an advertisement of which a bid amount designated by an advertiser for displaying the advertisement in the advertisement display area satisfies a predetermined condition, as an advertisement to be displayed in the advertisement display area, with high priority among advertisements corresponding to the keyword.

6. The information processing device according to claim 1,
wherein the determining code causes at least one of said at least one processor to determine an advertisement of a commodity purchased by the supervisor, as an advertisement to be displayed in the advertisement display area, with high priority among advertisements corresponding to the keyword.

7. The information processing device according to claim 6,
wherein the determining code causes at least one of said at least one processor to determine an advertisement of a commodity purchased within a predetermined period before date and time of registration of an article including the keyword in the web site, as an advertisement to be displayed in the advertisement display area, with high priority.

8. The information processing device according to claim 6,
wherein the determining code causes at least one of said at least one processor to determine an advertisement of a commodity of which purchasing date and time is closest to date and time of registration among commodities purchased before the date and time of the registration of an article including the keyword in the web site, as an advertisement to be displayed in the advertisement display area, with high priority.

9. The information processing device according to claim 1,
wherein the determining code causes at least one of said at least one processor to determine an advertisement of a commodity read by the supervisor, as an advertisement to be displayed in the advertisement display area, with high priority, among advertisements corresponding to the keyword.

10. The information processing device according to claim 9,
wherein the determining code causes at least one of said at least one processor to determine an advertisement of a commodity read within a predetermined period before date and time of registration of an article including the keyword in the web site, as an advertisement to be displayed in the advertisement display area, with high priority.

11. The information processing device according to claim 9,
wherein the determining code causes at least one of said at least one processor to determine an advertisement of a commodity of which reading date and time is closest to the date and time of the registration among commodities read before the date and time of the registration of an article including the keyword in the web site, as an advertisement to be displayed in the advertisement display area, with high priority.

12. The information processing device according to claim 9,
wherein the determining code causes at least one of said at least one processor to determine an advertisement of a highly ranked commodity of which the number of times of reading is large among commodities read before the date and time of the registration of an article including the keyword in the web site, as an advertisement to be displayed in the advertisement display area, with high priority.

13. The information processing device according to claim 1,
wherein the determining code causes at least one of said at least one processor to determine an advertisement of a commodity that has been linked by the supervisor and has been purchased by a purchaser through the link among advertisements corresponding to the keyword, as an advertisement to be displayed in the advertisement display area, with high priority.

14. The information processing device according to claim 13,
wherein the determining code causes at least one of said at least one processor to determine an advertisement of a highly ranked commodity of which the number of purchases is large among commodities that have been linked by the supervisor and have been purchased by a purchaser through the link, as an advertisement to be displayed in the advertisement display area, with high priority.

15. The information processing device according to claim 13,
wherein the determining code causes at least one of said at least one processor to determine an advertisement of a highly ranked commodity of which an increasing rate of the number of purchases within a latest past predetermined period is high among commodities that have been linked by the supervisor and have been purchased by a purchaser through the link, as an advertisement to be displayed in the advertisement display area, with high priority.

16. The information processing device according to claim 1,
wherein the determining code causes at least one of said at least one processor to determine an advertisement to be displayed in the advertisement display area, among advertisements corresponding to the keyword, based on evaluations made by the supervisor for commodities purchased by the supervisor.

17. The information processing device according to claim 16,
wherein the determining code causes at least one of said at least one processor to determine a highly ranked advertisement of a commodity of which the evaluation is high among the commodities evaluated by the supervisor, as an advertisement to be displayed in the advertisement display area, with high priority.

18. The information processing device according to claim 16,
wherein the determining code causes at least one of said at least one processor to exclude a lowly ranked commodity of which the evaluation is low among the commodities evaluated by the supervisor, from a determination target.

19. The information processing device according to claim 1,
wherein the determining code causes at least one of said at least one processor to determine an advertisement to be displayed in the advertisement display area, based on the history information of a reference range set for each commodity classification.

20. The information processing device according to claims 19,
wherein the reference range is a range corresponding to a working life set for each commodity classification.

21. The information processing device according to claims 19,
wherein the reference range is a range corresponding to season information set for each commodity classification.

22. An information processing method executed by a computer, the information processing method comprising:
acquiring a keyword specified from a Web page, on which an advertisement display area used for displaying an advertisement is arranged, said Web page being transmitted from a server to a terminal device through a network, and being displayed on a display screen of the terminal device;
acquiring history information of a supervisor, from a history database which stores at least one piece of history information of purchase history, reading history, review posting history, and affiliate history of the supervisor supervising the Web page;
selecting advertisements corresponding to the keyword acquired, from an advertisement database which stores at least advertisement ID of advertisement, and commodity information of commodity of advertisement target as each information of a plurality of advertisements, and determining, from the selected advertisements, an advertisement specified by the history information acquired, as an advertisement to be displayed in the advertisement display area of the Web page; and the history information acquired, from a storage storing information of a plurality of advertisements
controlling the display of the advertisement determined, in an advertisement display area of the Web page.

23. (canceled)
